(19) United States
(12) Patent Application Publication
(10) Pub. No.: US 2025/0190694 A1
(43) Pub. Date: Jun. 12, 2025

(54) LIMITING UNDESIRED LARGE LANGUAGE MODEL (LLM) OUTPUT

(71) Applicant: INTERNATIONAL BUSINESS MACHINES CORPORATION, ARMONK, NY (US)

(72) Inventors: AARON KIPPINS, BEACON, NY (US); JEFFREY BISTI, NEW PALTZ, NY (US); MICHAEL E. GILDEIN, WAPPINGERS FALLS, NY (US); PASQUALE A. CATALANO, WALLKILL, NY (US); RYAN THOMAS RAWLINS, NEW PALTZ, NY (US)

(21) Appl. No.: 18/532,408

(22) Filed: Dec. 7, 2023

(51) Int. Cl. G06F 40/20

(52) U.S. Cl. CPC G06F 40/20

(57) ABSTRACT

Limiting undesired large language model (LLM) output, including: detecting that an output of a large language model (LLM) satisfies one or more conditions indicating that the output is undesirable; identifying a path in the large language model used to generate the output; and performing, based on the path, one or more remedial actions to modify how the path affects output by the LLM.

### BACKGROUND

The present disclosure relates to methods, apparatus, and products for limiting undesired large language model (LLM) output.

### SUMMARY

According to embodiments of the present disclosure, various methods, apparatus and products for limiting undesired large language model (LLM) output are described herein. In some aspects, limiting undesired large language model (LLM) output includes detecting that an output of a large language model (LLM) satisfies one or more conditions indicating that the output is undesirable; identifying a path in the large language model used to generate the output; and performing, based on the path, one or more remedial actions to modify how the path affects output by the LLM.

In some aspects, the one or more remedial actions includes modifying one or more parameters of the LLM associated with the path. This allows the way the LLM processes input using the identified path to be modified without the need to retrain the LLM itself. In some aspects, the one or more remedial actions includes flagging at least a portion of the path; detecting that the flagged at least a portion of the path was used in generating another output by the LLM; and validating, responsive to the at least a portion of the path being used, the other output. This allows for selective validation of LLM output when that output was generated using a previously flagged portion of the LLM known to produce undesirable output.

In some aspects, an apparatus may include a processing device; and memory operatively coupled to the processing device, wherein the memory stores computer program instructions that, when executed, cause the processing device to: detect that an output of a large language model (LLM) satisfies one or more conditions indicating that the output is undesirable; identify a path in the large language model used to generate the output; and perform, based on the path, one or more remedial actions to modify how the path affects output by the LLM.

In some aspects, the one or more remedial actions includes modifying one or more parameters of the LLM associated with the path. This allows the way the LLM processes input using the identified path to be modified without the need to retrain the LLM itself. In some aspects, the one or more remedial actions includes flagging at least a portion of the path; detecting that the flagged at least a portion of the path was used in generating another output by the LLM; and validating, responsive to the at least a portion of the path being used, the other output. This allows for selective validation of LLM output when that output was generated using a previously flagged portion of the LLM known to produce undesirable output.

In some aspects, a computer program product comprising a computer readable storage medium may store computer program instructions that, when executed: detect that an output of a large language model (LLM) satisfies one or more conditions indicating that the output is undesirable; identify a path in the large language model used to generate the output; and perform, based on the path, one or more remedial actions to modify how the path affects output by the LLM.

In some aspects, the one or more remedial actions includes modifying one or more parameters of the LLM associated with the path. This allows the way the LLM processes input using the identified path to be modified without the need to retrain the LLM itself. In some aspects, the one or more remedial actions includes flagging at least a portion of the path; detecting that the flagged at least a portion of the path was used in generating another output by the LLM; and validating, responsive to the at least a portion of the path being used, the other output. This allows for selective validation of LLM output when that output was generated using a previously flagged portion of the LLM known to produce undesirable output.

### BRIEF DESCRIPTION OF THE DRAWINGS

FIG. 1 sets forth an example computing environment for limiting undesired large language model (LLM) output in accordance with some embodiments of the present disclosure.

FIG. 2 sets forth a flowchart of an example method for limiting undesired large language model (LLM) output in accordance with some embodiments of the present disclosure.

FIG. 3 sets forth a flowchart of another example method for limiting undesired large language model (LLM) output in accordance with some embodiments of the present disclosure.

FIG. 4 sets forth a flowchart of another example method for limiting undesired large language model (LLM) output in accordance with some embodiments of the present disclosure.

FIG. 5 sets forth a flowchart of another example method for limiting undesired large language model (LLM) output in accordance with some embodiments of the present disclosure.

### DETAILED DESCRIPTION

Neural network machine learning models, such as large language models (LLMs) may be trained using data from vast, un-curated, and variable datasets which may introduce unintentional bias, inaccurate information, and undesired model knowledge. Furthermore, continuous or online training of models can introduce significant drift over time from the original models, also introducing these undesired learning behaviors or information. For example, over time a LLM may be trained with enough data to provide, when prompted, illegal information or sources of illegal information, illicit or age-restricted content, and the like. Though rules or models may be used to analyze the input or output of the LLM and restrict any undesired output, these mechanisms can be circumvented through various exploits, particularly using exploits that tailor a prompt or input to the LLM to generate some otherwise restricted output.

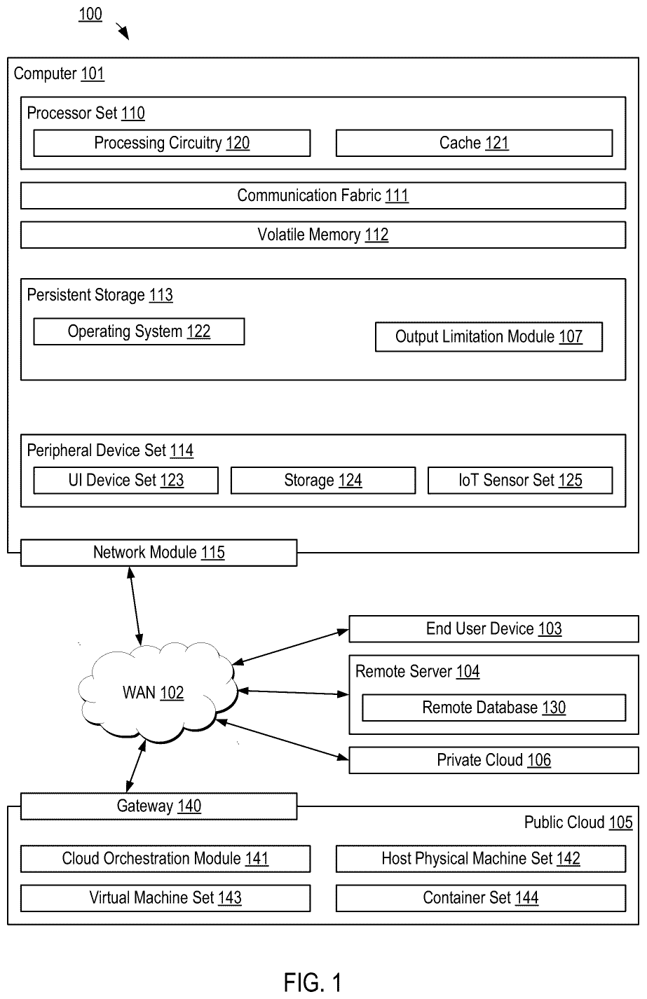

With reference now to FIG. 1, shown is an example computing environment according to aspects of the present disclosure. Computing environment 100 contains an example of an environment for the execution of at least some of the computer code involved in performing the various methods described herein, such as the output limitation module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

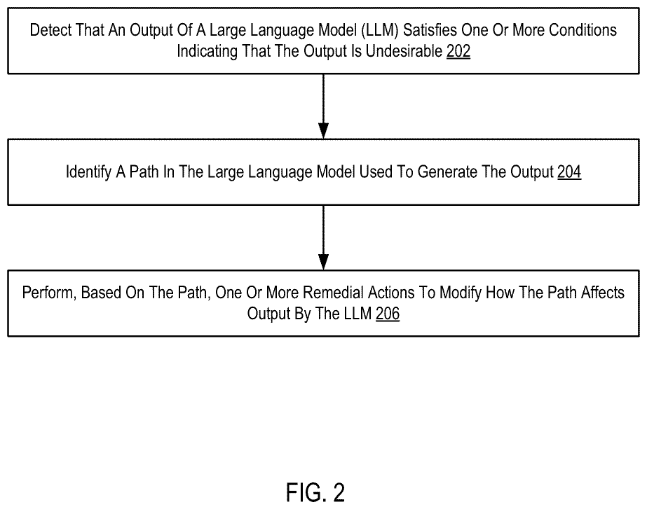

For further explanation, FIG. 2 sets forth a flowchart of an example method of limiting undesired large language model (LLM) output in accordance with some embodiments of the present disclosure. The method of FIG. 2 may be performed by the output limitation module 107 of FIG. 1. For example, the output limitation module 107 may include a program or service executed concurrently to some large language model (LLM), with the output limitation module 107 accepting, as input, output from the LLM. The output limitation module 107 may also have access or privileges to modify various parameters of the LLM, as will be described in further detail below. Although the following discussion describes limitation of output from a LLM, one skilled in the art will appreciate that the approaches set forth herein are applicable to other neural networks, machine learning models, and the like.

The method of FIG. 2 includes detecting 202 that an output of a large language model (LLM) satisfies one or more conditions indicating that the output is undesirable. As described herein, a LLM is an artificial neural network trained to achieve general-purpose language understanding and generation through training on a sufficiently large data set. The LLM accepts, as input, a natural language structured prompt soliciting some output from the LLM. The LLM then provides some output based on that prompt. As the LLM is trained on a large, varied, data set and may be continually retrained over time, the LLM may be sufficiently trained such that it can provide output deemed undesirable according to some criteria. For example, certain information may be illegal, may enable dangerous activity, may include content deemed inappropriate for certain audiences, and the like. Readers will appreciate that the particular criteria for undesirable content may vary according to design considerations. The output of the LLM may include some output generated by the LLM in response to a prompt, such as a user prompt.

Accordingly, detecting 202 that the output of a LLM satisfies one or more conditions indicating that the output is undesirable includes analyzing or otherwise validating the output of the LLM to determine whether it is undesirable according to the particular conditions or criteria for undesirable output. In some embodiments, detecting 202 that the output of a LLM satisfies one or more conditions indicating that the output is undesirable includes applying one or more rules to the output of the LLM. For example, the rules may define particular keywords or phrases that, if present or if similar values are present, may indicate that the output is undesirable. As another example, the output of the LLM may be compared to other data sources to determine if the output contains content matching or similar to data in these other data sources. In some embodiments, detecting 202 that the output of a LLM satisfies one or more conditions indicating that the output is undesirable includes performing a sentiment analysis or other natural language analysis on the output. The product of this analysis may also be subject to the one or more rules to detect 202 an undesirable output.

In some embodiments, detecting 202 that the output of a LLM satisfies one or more conditions indicating that the output is undesirable includes applying one or more models to the output of the LLM. Such one or more models may be trained to identify undesirable output (e.g., using a corpus of training data including examples of undesirable output). In some embodiments, the one or more models may be used to classify or tag the output or portions of the output. In some embodiments, particular classifications or tags of output may indicate that the output of the LLM is undesirable. One skilled in the art will appreciate that these approaches for detecting 202 undesirable LLM output are merely exemplary and that other approaches are also contemplated within the scope of the present disclosure. In some embodiments, detecting 202 that the output of a LLM satisfies one or more conditions indicating that the output may cause presentation of the output (e.g., providing the output to a user) may be suppressed. In some embodiments, detecting 202 that the output of a LLM satisfies one or more conditions indicating that the output may allow presentation of the output.

The method of FIG. 2 also includes identifying 204 a path (e.g., an activated path) in the LLM used to generate the output. A path in the LLM is a path of neurons or other linked nodes in the model activated during process of the input prompt in order to generate the output. Put differently, where the LLM may be embodied or expressed as a directed graph of neurons or nodes activated for processing the input prompt, the path may correspond to a path of this directed graph. In some embodiments, identifying 204 the path in the LLM used to generate the output may be performed in response to detecting 202 that the output satisfies the one or more conditions indicating that the output is undesirable. In some embodiments, identifying 204 the path in the LLM used to generate the output may include reinputting the input used to generate the undesirable output and monitoring activity or calculations of the LLM to identify the path used to generate the output. In some embodiments, identifying 204 the path in the LLM used to generate the output may include accessing log data or other information generated when the LLM initially processed the input to generate the undesirable output and deriving the path from that log data.

The method of FIG. 2 also includes performing 206, based on the path, one or more remedial actions to modify how the path affects output by the LLM. As the undesired output was generated using the identified 204 path, the one or more remedial actions modify how the identified 204 path is used to generate output by the LLM. As will be described in further detail below, in some embodiments, the one or more remedial actions may include modifying various parameters of the LLM along the identified path or flagging the path or a subset of the path such that activation of the flagged portion of the LLM triggers validation of the generated output by the LLM. Particularly, the one or more remedial actions modify how the path affects output by the LLM without retraining the LLM. This allows for undesired output by the LLM to be limited or modified without computationally expensive retraining. Moreover, this ensures that the portions of the LLM used to generate the LLM are substantively affected, which may not occur during retraining.

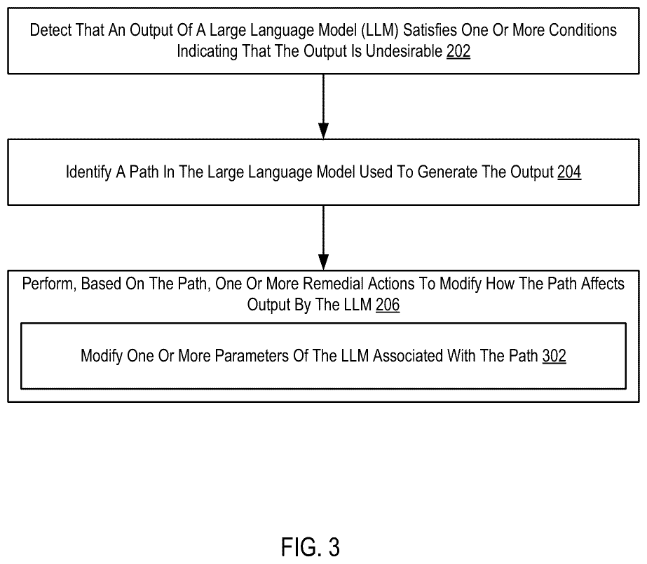

For further explanation, FIG. 3 sets forth a flowchart of another example method for limiting undesired large language model (LLM) output in accordance with some embodiments of the present disclosure. The method of FIG. 3 is similar to FIG. 2 in that the method of FIG. 3 also includes detecting 202 that an output of a large language model (LLM) satisfies one or more conditions indicating that the output is undesirable; identifying a path in the large language model used to generate the output; and performing 206, based on the path, one or more remedial actions to modify how the path affects output by the LLM.

The method of FIG. 3 differs from FIG. 2 in that performing 206, based on the path, one or more remedial actions to modify how the path affects output by the LLM includes modifying 302 one or more parameters of the LLM associated with the path. In some embodiments, the one or more parameters may include one or more weights of the LLM associated with the path. For example, the one or more weights of the LLM associated with the path may be reduced such that the path has less of an impact on the output of the LLM. In some embodiments, the one or more parameters may include one or more activation thresholds associated with the path, such as activation thresholds for neurons on the path. For example, the one or more activation thresholds may be increased such that activation of the particular neurons on the path would be less likely to be triggered, thereby reducing the impact that the path has on the output of the LLM.

By modifying 302 the one or more parameters of the LLM associated with the path, the way the LLM processes data may be modified without the need to retrain the LLM, thereby limiting undesirable output by the LLM without computationally expensive retraining of the LLM. Thus, a path of the LLM known to produce undesirable output may have its associated parameters modified to reduce the likelihood that this path will be taken, and thereby reduce the likelihood that an undesirable output will be generated by the LLM.

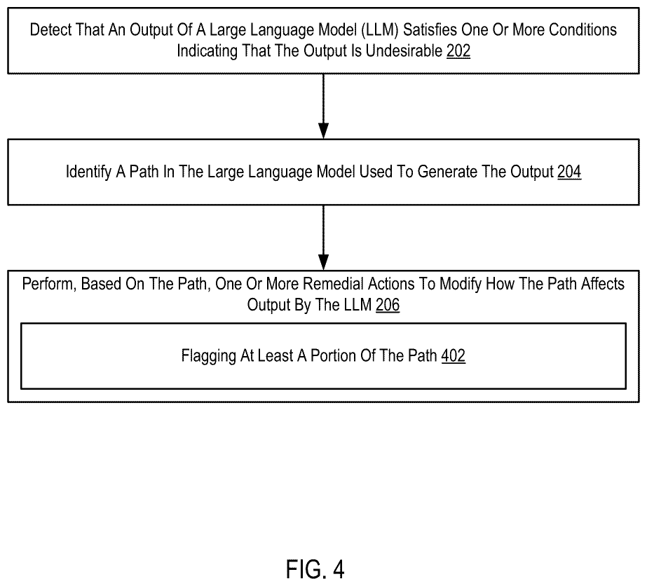

For further explanation, FIG. 4 sets forth a flowchart of another example method for limiting undesired large language model (LLM) output in accordance with some embodiments of the present disclosure. The method of FIG. 4 is similar to FIG. 2 in that the method of FIG. 4 also includes detecting 202 that an output of a large language model (LLM) satisfies one or more conditions indicating that the output is undesirable; identifying a path in the large language model used to generate the output; and performing 206, based on the path, one or more remedial actions to modify how the path affects output by the LLM.

The method of FIG. 4 differs from FIG. 2 in that performing 206, based on the path, one or more remedial actions to modify how the path affects output by the LLM includes flagging 402 at least a portion of the path. Flagging 402 the at least a portion of the path includes storing data indicating that the at least a portion of the path was used to generate an undesirable output such that future usage of the flagged at least a portion of the path may trigger validation or review of the associated LLM output. For example, in some embodiments, the LLM may be modified such that activation of the flagged at least a portion of the path produces a signal, command, exception, event, and the like may be generated. As another example, data identifying the flagged at least a portion of the path may be stored. During processing of inputs by the LLM, activated portions of the LLM may be compared to data identifying flagged portions of the LLM to determine whether a flagged portion was activated. As a further example, the neurons or other sub-path of the LLM may be assigned a score or evaluation indicating a degree to which they were used in generating an undesirable output. Flagging 402 the at least a portion of the path may cause the scores of the neurons along the flagged at least a portion of the path to be increased. In such embodiments, review or validation of the output by the LLM may be triggered when some neuron or sub-path having a score exceeding a threshold was used to generate the particular output.

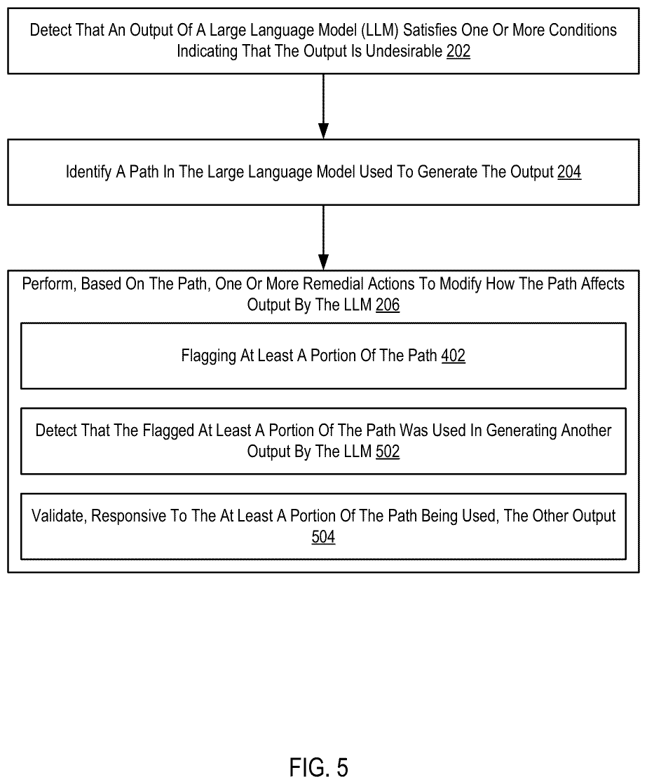

For further explanation, FIG. 5 sets forth a flowchart of another example method for limiting undesired large language model (LLM) output in accordance with some embodiments of the present disclosure. The method of FIG. 5 is similar to FIG. 4 in that the method of FIG. 5 also includes detecting 202 that an output of a large language model (LLM) satisfies one or more conditions indicating that the output is undesirable; identifying a path in the large language model used to generate the output; and performing 206, based on the path, one or more remedial actions to modify how the path affects output by the LLM, including flagging 402 at least a portion of the path.

The method of FIG. 5 differs from FIG. 4 in that performing 206, based on the path, one or more remedial actions to modify how the path affects output by the LLM also includes detecting 502 that the flagged at least a portion of the path was used in generating another output by the LLM. In some embodiments, detecting 502 that the flagged at least a portion of the path was used in generating another output by the LLM includes detecting any usage or activation of the flagged at least a portion of the path by the LLM. In some embodiments, such as embodiments where flagging causes a score or rating associated with the flagged portion to be increased, detecting 502 that the flagged at least a portion of the path was used in generating another output by the LLM includes determining that the score or rating associated with the flagged portion meets or exceeds a threshold. Thus, usage of a particular portion of the LLM in generating some undesirable output must meet some minimum threshold before triggering validation of the output.

The method of FIG. 5 further differs from FIG. 4 in that performing 206, based on the path, one or more remedial actions to modify how the path affects output by the LLM also includes validating 504, responsive to the at least a portion of the path being used, the other output. In some embodiments, validating 504 the other output includes determining whether the other output is an undesirable output (e.g., satisfies the one or more conditions indicating that the output is undesirable). Accordingly, in some embodiments, validating 504 the other output may be performed using similar approaches as described above in detecting 202 that an output of a LLM satisfies one or more conditions indicating that the output is undesirable, including a rules-based approach, a model-based approach, combinations thereof, and the like. In some embodiments, validating 504 the other output includes triggering a manual review of the other output. In some embodiments, validating 504 the other output includes comparing the other output to a known malicious output generated by the LLM in response to a known malicious prompt. Where a degree of similarity between the other output and the known malicious output meets some threshold or other criteria, the other output may be deemed to be an undesirable output.

The approaches set forth above allow for selective validation of LLM output where a path or portion of a path known to produce undesirable output is used to generate some other output. This saves computational and processing resources compared to approaches where all output of the LLM should be subject to validation. Thus, these particular remedial actions modify how the path affects output by the LLM in that output generated using the path is subject to selective validation.

Although FIGS. 3-5 are shown as separate approaches for performing 206 remedial actions, one skilled in the art will appreciate that, in some embodiments, a combination of these remedial actions may be used. For example, the one or more parameters of the LLM associated with the identified path may be modified. Additionally, at least a portion of the path may also be flagged. This allows for selective validation of the LLM output to be performed when using a path of the LLM where the likelihood of using that path was already reduced by virtue of modifying the parameters of the LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting that an output of a large language model (LLM) satisfies one or more conditions indicating that the output is undesirable;
identifying a path in the large language model used to generate the output; and
performing, based on the path, one or more remedial actions to modify how the path affects output by the LLM.

2. The method of claim 1, wherein performing the one or more remedial actions comprises modifying one or more parameters of the LLM associated with the path.

3. The method of claim 2, wherein the one or more parameters comprises one or more weights.

4. The method of claim 2, wherein the one or more parameters comprises one or more activation thresholds.

5. The method of claim 1, wherein performing the one or more remedial actions comprises flagging at least a portion of the path.

6. The method of claim 5, wherein performing the one or more remedial actions comprises:
detecting that the flagged at least a portion of the path was used in generating another output by the LLM; and
validating, responsive to the at least a portion of the path being used, the other output.

7. The method of claim 1, wherein the one or more remedial actions are performed without retraining the LLM.

8. An apparatus comprising:
a processing device; and
memory operatively coupled to the processing device, wherein the memory stores computer program instructions that, when executed, cause the processing device to:
detect that an output of a large language model (LLM) satisfies one or more conditions indicating that the output is undesirable;
identify a path in the large language model used to generate the output; and
perform, based on the path, one or more remedial actions to modify how the path affects output by the LLM.

9. The apparatus of claim 8, wherein performing the one or more remedial actions comprises modifying one or more parameters of the LLM associated with the path.

10. The apparatus of claim 9, wherein the one or more parameters comprises one or more weights.

11. The apparatus of claim 9, wherein the one or more parameters comprises one or more activation thresholds.

12. The apparatus of claim 8, wherein performing the one or more remedial actions comprises flagging at least a portion of the path.

13. The apparatus of claim 12, wherein performing the one or more remedial actions comprises:
detecting that the flagged at least a portion of the path was used in generating another output by the LLM; and
validating, responsive to the at least a portion of the path being used, the other output.

14. The apparatus of claim 8, wherein the one or more remedial actions are performed without retraining the LLM.

15. A computer program product comprising a computer readable storage medium, wherein the computer readable storage medium comprises computer program instructions that, when executed:
detect that an output of a large language model (LLM) satisfies one or more conditions indicating that the output is undesirable;
identify a path in the large language model used to generate the output; and
perform, based on the path, one or more remedial actions to modify how the path affects output by the LLM.

16. The computer program product of claim 15, wherein performing the one or more remedial actions comprises modifying one or more parameters of the LLM associated with the path.

17. The computer program product of claim 16, wherein the one or more parameters comprises one or more weights.

18. The computer program product of claim 16, wherein the one or more parameters comprises one or more activation thresholds.

19. The computer program product of claim 15, wherein performing the one or more remedial actions comprises flagging at least a portion of the path.

20. The computer program product of claim 19, wherein performing the one or more remedial actions comprises:
detecting that the flagged at least a portion of the path was used in generating another output by the LLM; and
validating, responsive to the at least a portion of the path being used, the other output.
